(19) United States
(12) Patent Application Publication
(10) Pub. No.: US 2024/0314061 A1
(43) Pub. Date: Sep. 19, 2024

(54) MANAGING CONFIGURATION OF SUPERNETS FOR A ROUTE TABLE BASED ON AVAILABLE CAPACITY IN THE ROUTE TABLE

(71) Applicant: VMware, LLC, Palo Alto, CA (US)

(72) Inventors: Anantha Mohan Raj M D, Bengaluru (IN); Paul Subhankar, Bangalore (IN); Chandan Ghosh, Bangalore (IN); Gaurav Jindal, Pune (IN); Sinchanaraj H N, Bengaluru (IN)

(21) Appl. No.: 18/184,055

(22) Filed: Mar. 15, 2023

(51) Int. Cl. H04L 45/023; H04L 45/586

(52) U.S. Cl. CPC H04L 45/023; H04L 45/586

(57) ABSTRACT

Described herein are systems, methods, and software to manage prefixes for a route table in a gateway according to an implementation. In one implementation, a management service monitors a quantity of prefix routes associated with a route table in a gateway and determines when the quantity satisfies one or more criteria. When the capacity satisfies the one or more criteria, the management service determines one or more supernets that each represent a subset of the prefix routes and adds the one or more supernets to the route table to replaces the subset of the prefix routes.

### TECHNICAL BACKGROUND

In computing environments, tiered routers can be used to provide multi-tenancy and support multiple networking segments of virtual machines. Each tier of the tiered routers can provide different functionality and support the communications of the virtual machines. The functionality can include route selection, firewall operations, network address translation, or some other operation. As an example, a first tier (referred to herein as “tier-0”) router can support connections to one or more second tier (referred to herein as “tier-1”) routers. Tier-0 routers can provide connections to one or more external networks (e.g., the internet) or services, while the one or more tier-1 routers can support more deployment specific operations for the segmented virtual machines (e.g., firewall operations). When a packet is received by the tier-0 router, the tier-0 router can process and forward the packet to a corresponding tier-1 router, wherein the tier-1 router can perform additional processing and forward the packet toward the destination virtual machine.

However, while tiered routers can be used to support multi-tenancy for an organization, difficulties can arise when coupling a tier-0 router to a gateway supported by a cloud service provider (e.g., Amazon Web Services™, Microsoft Azure™, or other service providers). These limitations can include route table capacity constraints that can limit the number of entries in a route table on the service provider gateway. The limited capacity can prevent new segments from being added to the environment or add complexity in managing the segments in a computing environment.

### SUMMARY

The technology described herein manages the configuration of supernets in a route table of a gateway. The supernets can be used to avoid capacity issues associated with cloud service provider gateways and avoid interruptions in connectivity for virtual machines. In one implementation, a management service for a gateway monitors a quantity of prefix routes associated with the gateway and determines when the quantity of prefixes satisfies one or more criteria. In response to satisfying the one or more criteria, the management service determines one or more supernets for the gateway, wherein each of the one or more supernets represent a subset of the prefix routes. Once the one or more supernets are identified, the management service adds the one or more supernets to the route table and removes the one or more subsets of the prefix routes represented by the one or more supernets from the route table.

### BRIEF DESCRIPTION OF THE DRAWINGS

FIG. 1 illustrates a computing environment to manage the configuration of supernets for a route table in a gateway according to an implementation.

FIG. 2 illustrates an operation of a management service to configure supernets for a route table in a gateway according to an implementation.

FIG. 3 illustrates an operational scenario of identifying supernets for segments in a computing environment according to an implementation.

FIG. 4 illustrates an operational scenario of updating supernets based on capacity thresholds according to an implementation.

FIG. 5 illustrates a management service computing system to manage supernets in a route table of a gateway according to an implementation.

### DETAILED DESCRIPTION

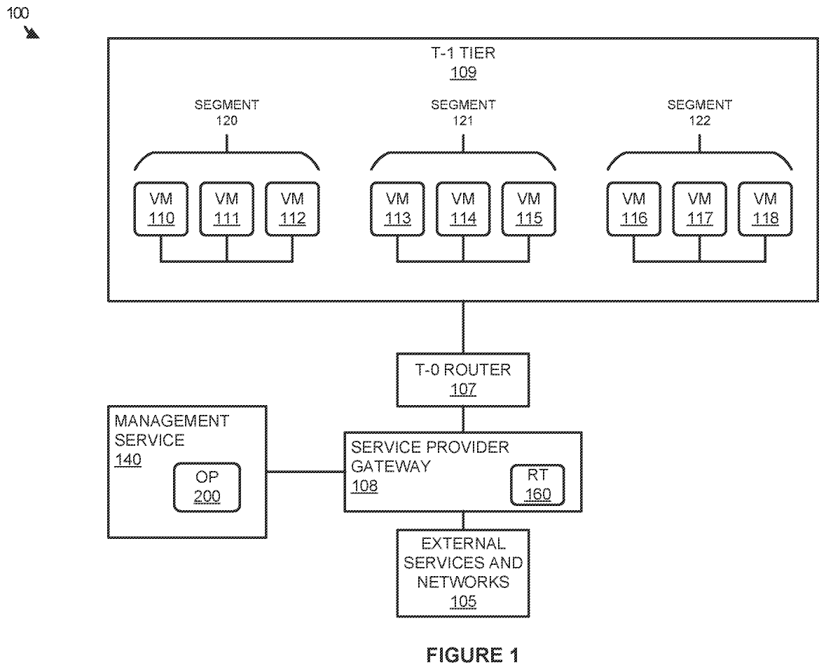

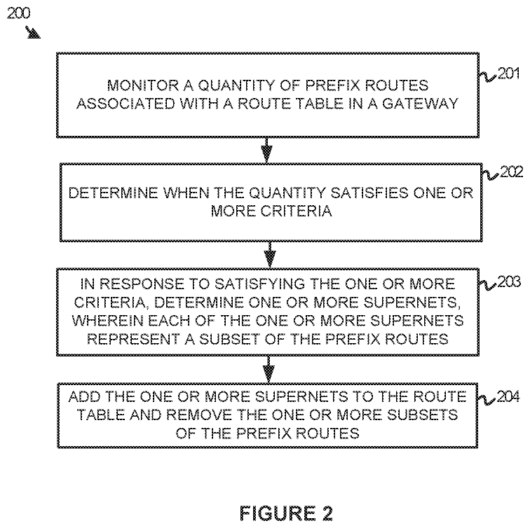

FIG. 1 illustrates a computing environment 100 to manage the configuration of supernets for a route table in a gateway according to an implementation. Computing environment 100 includes external services and networks 105, tier-0 (T-0) router 107, service provider gateway 108, tier-1 (T-1) tier 109, and management service 140. T-1 tier 109 further includes segments 120-122 with virtual machines (VMs) 110-118, wherein segments 120-122 each comprise a subnet of network addresses. Service provider gateway 108 further includes route table (RT) 160, wherein service provider gateway 108 is representative of a gateway supported by the web service provider (e.g., Amazon Web Services™, Microsoft Azure™, etc.), such as a virtual private cloud (VPC) router, internet gateway (IGW), or some other gateway. Management service 140 provides operation 200 that is described below with respect to FIG. 2. Management service 140 can be implemented on one or more computers in computing environment 100.

In computing environment 100, T-0 router 107 is used to provide connectivity for virtual machines 110-118 to external services and networks 105 via service provider gateway 108. External services and networks 105 can include services provided by a cloud service provider (e.g., VPC), the internet, or some other service. Service provider gateway 108 includes route table 160 that is used to direct and manage packets for virtual machines 110-118. Service provider gateway 108 can receive packets from the external networks and direct packets toward T-0 router 107 and T-1 tier 109, wherein T-1 tier 109 includes gateways that are used to support multi-tenancy or the deployment of different segments 120-122. T-0 router 107 can support address translation, firewall operations, or some other routing operation. T-0 router 107 can also support the communication of egress packets from T-1 tier 109 to external networks and services using service provider gateway 108.

When a segment of segments 120-122 is deployed within computing environment 100, the segment is allocated a subnet for virtual machines within the segment. Thus, segment 120 is assigned a first subnet, segment 121 is assigned a second subnet, and segment 122 is assigned a third subnet. Route table 160 uses addresses (or prefixes associated with the subnets) to forward the packets within computing environment 100. For example, a packet received at service provider gateway 108 with a prefix that corresponds to a virtual machine in segment 120 will be forwarded toward a T-1 router in T-1 tier 109 associated with segment 120.

However, as the number of segments increase in the computing environment, route table 160 can approach a limit of prefix addresses or routes available for the table. Here, management service 140 can identify the quantity of address prefixes associated with route table 160 and update route table 160 to prevent the table from exceeding the available limit. In at least one implementation, management service 140 can determine when the quantity of prefix routes associated with the table satisfy one or more criteria (e.g., 80 percent usage of the total entries for prefixes in the table). When the usage is exceeded for route table 160, management service 140 can combine the subnets of the segments into supernets, wherein the supernets each aggregate multiple subnets to reduce the quantity of entries in route table 160. As an example, when route table 160 satisfies one or more criteria to trigger the aggregation or combination of segments into a supernet, management service 140 can determine which segments of segments 120-122 are most efficient to combine into a supernet. Segment 120 can correspond to a subnet of 192.168.1.0/24 and segment 121 can correspond to a subnet of 192.168.2.0/24, while segment 122 corresponds to a subnet of 172.160.1.0/24. In this example, the subnets for segments 120-121 can be combined into a supernet, while segment 122 is not included in a supernet. This can reduce the number of entries from three in route table 160 to two entries.

In some implementations, when determining whether the one or more criteria are satisfied to determine one or more new supernets for T-1 tier 109, management service 140 can monitor the quantity of current prefixes in route table 160 and the quantity of pending prefixes (associated with new or queued segments) to be added to route table 160. If the sum of the two satisfies criteria (i.e., exceeds a threshold), management service 140 will determine one or more supernets for route table 160. Once the supernets are identified that each include a subset of the subnets associated with the route table, the supernets are added to the route table to replace the two or more subnets associated with each of the supernets. The selection of the subnets for each of the supernets is discussed further in the below FIGS. 2-4.

In some implementations, the prefixes that are included in route table 160 may not comprise the prefixes used to address the segments in T-1 tier 109. Rather, the T-0 or T-1 routers can be used to perform network address translation to convert a first address to a second address. Thus, while service provider gateway 108 can forward a packet based on a first prefix for a first network address, the first network address can be subsequently translated prior to being forwarded to the corresponding virtual machine in T-1 tier 109. Further, description of the NAT operations and the topology is described in U.S. Pat. No. 11,343,227, which is incorporated by reference herein.

FIG. 2 illustrates an operation 200 of a management service to configure supernets for a route table in a gateway according to an implementation. The steps of operation 200 are referenced parenthetically in the paragraphs that follow with reference to systems and elements of computing environment 100 of FIG. 1.

Operation 200 includes monitoring (201) a quantity of prefix routes associated with a route table 160 in service provider gateway 108. Service provider gateway 108 acts as a service provider router that can connect to external networks and services, such as a VPC. T-0 router 107 can provide network address translation (NAT) operations, virtual private networking (VPN) operations, firewall operations, or some other networking operations. T-0 router 107 connects to one or more T-1 routers that correspond to tenants, wherein each of the tenant routers can provide additional firewall rules and routing configurations (NAT, VPN, etc.) associated with the coupled virtual machines. In some implementations, in monitoring the quantity of prefix routes associated with route table 160, operation 200 can determine a quantity of existing routes in route table 160 and the quantity of pending routes to be added to route table 160. For example, when a new segment is to be added to computing environment 100, the prefix or subnet associated with the segment can be added to the quantity of prefix routes associated with the route table.

Operation 200 further determines (202) when the quantity satisfies one or more criteria, wherein the one or more criteria can correspond to a capacity limitation associated with service provider gateway 108. As an example, route table 160 can be capable of supporting 100 prefix routes that direct packets for segments of IP addresses. When the quantity of prefix routes associated with route table 160 reaches a threshold percentage of the 100 prefix routes, management service 140 and operation 200 can determine that the quantity satisfies the one or more criteria. If the quantity does not satisfy the one or more criteria, then no action is taken with regards to updating the route table with supernets. However, when the quantity does satisfy the one or more criteria, operation 200 determines (203) one or more supernets for the route table, wherein each supernet of the one or more supernets represent a subset of the prefix routes.

As an example, when route table 160 at service provider gateway 108 satisfies the one or more criteria, management service 140 can identify prefixes associated with route table 160, wherein the prefixes can include the prefixes existing in route table 160 and prefixes queued to be added to route table 160 and deployed as a segment in T-1 tier 109. Here, segment 120 can correspond to a subnet of 192.168.1.0/24 and segment 121 can correspond to a subnet of 192.168.2.0/24, while segment 122 corresponds to a subnet of 172.160.1.0/24. When the quantity of prefix routes (i.e., the /24 routes) exceed the threshold for route table 160, management service 140 can combine subnets into a supernet to reduce the quantity address prefixes in route table 160.

In one example, management service 140 can identify the first two octets of the prefix routes associated with the route table and group the prefix routes that share the first two octets into a single supernet. The supernet will reflect the shared bits between the prefix routes (subnets) and the length of the shared bits. Thus, using the previous example, the octets would be 172.168 and 172.160 and the subnets that qualify for the octet can be used to determine the supernet. The supernet will represent the longest matching prefix for the subnets that qualify for each octet. Thus, for segments 120-121 in the previous example, the supernet would be 192.168.1.0/22.

In another example, management service 140 can look to determine commonalities in the prefixes of the subnets and determine when the subnets reduce the quantity of prefixes associated with route table 160 by a threshold amount. Using the example subnet routes above, management service 140 can move to the next higher prefix to determine commonalities between the prefixes or the first 23 bits of the prefix. If commonalities exist, then subnets will be combined into one or more supernets and management service 140 will determine whether the identified one or more supernets reduce the quantity of prefix routes for route table 160 by a requisite amount. If the newly identified supernets do not reduce the prefix routes by the requisite amount (or no supernets could be identified using the first 23 bits), then management service 140 can move to the first 22 bits and repeat the operation as necessary until the prefix routes associated with route table 160 is reduced by the requisite amount. Using the example above, segments 120-121 share the first 22 bits and can be included in a supernet that includes at least the first 22 bits (e.g., a supernet of 192.168.1.0/22). Although two example processes for determining supernets are provided herein, the supernets can be generated or determined using other operations including matching arbitrary length prefixes (i.e., matching prefixes with the matching first 18 bits instead of two octets), or some other mechanism.

Once the one or more supernets are identified, operation 200 further adds (204) the one or more supernets to the route table and removes the one or more subsets of the prefix routes represented by the one or more supernets from the route table. In some implementations, when adding the one or more supernets, the supernets are added to route table 160 prior to removing any prefixes associated with the subnets associated with the supernets. Advantageously, management service 140 will only remove the current prefix routes when a supernet is added to take its place. Using the example of generating a supernet for segments 120-121, a supernet is added for route table 160 that includes a prefix associated with both segments. Once added, the individual subnets are removed from route table 160 to use the supernet in place of the subnets. When using the supernet, packets can be forwarded to an intermediary router that in turn forwards the packets to the T-1 router associated with the segment.

In some implementations, after supernets are applied for route table 160, additional segments can be queued in computing environment 100. When the segment belongs to a supernet, the quantity of prefixes associated with route table 160 is unchanged as the subnet would be included or be routed using the existing supernet. However, if the new segment does not belong to an existing supernet the quantity of prefixes associated with the route table is increased and is used to determine whether to determine one or more new supernets for route table 160.

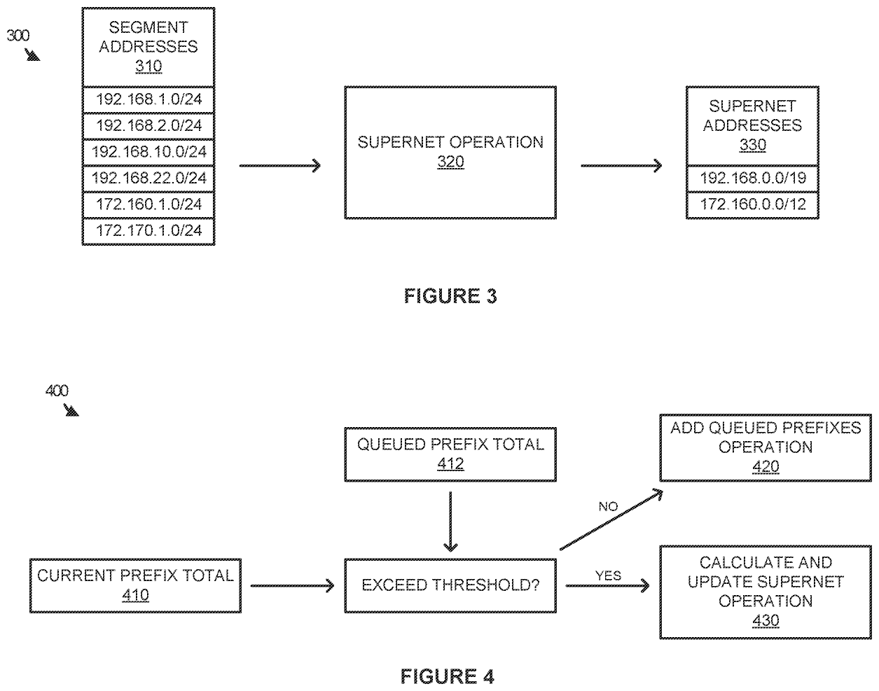

FIG. 3 illustrates an operational scenario 300 of identifying supernets for segments in a computing environment according to an implementation. Operational scenario 300 includes segment addresses 310, supernet operation 320, and supernet addresses 330.

As described herein, a management service for a computing environment can monitor the available capacity at a service provider router for prefixes associated with a route table. The available capacity can be monitored based on the sum of current prefixes in the route table and pending or queued prefixes associated with segments to be added to the route table. When the sum exceeds a threshold, the management service can perform supernet operation 320.

Supernet operation 320 identifies prefixes associated with the route table and determines supernets to reduce the quantity of prefixes associated with the route table. In at least one example, supernet operation 320 identifies prefixes associated with the subnets in the computing environment and identifies commonalities in bits between the different subnets. Using the example of operational scenario 500, supernet addresses 330 comprise address 192.168.0.0/19, which is a supernet for the subnets defined by addresses 192.169.1.0/24, 192.169.2.0/24, 192.169.10.0/24, and 192.169.22.0/24. Additionally supernet addresses 330 includes 172.160.0.0/12 that corresponds to the segment addresses 172.160.1.0/24 and 172.170.1.0/24. After the supernets are identified, the supernets can be added in the route table and replace the corresponding prefixes represented by the supernets, wherein the supernets are added prior to the removal of the prefixes to eliminate downtime in communications for the virtual machines in the subnets.

In one implementation, supernet operation 320 can determine the supernets using the first two octets associated with the prefixes associated with the current route table. Using the example in operational scenario 300, the two octets would include 192.168 and 172.160. Once the two octets are identified, the prefixes in those octets can be used to generate the supernet, wherein the supernet would include a prefix that represents the shared bits for the prefixes with 192.168 or 172.160. Thus, a first supernet of 192.168.0.0/19 is identified for the first four entries in segment addresses 310 and a second supernet of 172.160.0.0/12 is identified for the last two entries in segment addresses 310.

In other implementations, supernet operation 320 can determine a current prefix length associated with each of the subnet prefixes (e.g., 24). Subnet operation 320 can then move to the next length (e.g., 23) and identify subnet prefixes that can be combined using the prefix length. Once subnet prefixes are combined, supernet operation 320 determines whether the prefixes reduce the prefixes associated with the route table to a threshold quantity. If the prefixes associated with the route table are reduced to a threshold quantity, then the route table can be updated with the prefixes. In contrast, if the prefixes are not reduced to the threshold quantity, then the process can be repeated by moving to the next smaller prefix and repeating the same operations. Although these are two examples of generating the supernets for a route table, management service 140 can use any other method to select the supernets that represent a subset of prefixes for various subnets.

In some examples, segment addresses 310 may represent different addresses than the addresses used to direct packets to the virtual machines in the segment. Rather, while the service provider gateway directs packets based on the prefixes in segment addresses 310, the router or routers between the service provider can perform network address translation on the address and forward the packet toward the destination virtual machine.

FIG. 4 illustrates an operational scenario 400 of updating supernets based on capacity thresholds according to an implementation. Operational scenario 400 includes current prefix total 410, queued prefix total 412, add queued prefixes operation 420, and calculate and update supernet operation 430. Operational scenario 400 is representative of the operations that can be performed by a management service, such as management service 140 of FIG. 1.

Operational scenario 400 determines the sum of a current prefix total 410 and a queued prefix total 412 for a route table at a service provider gateway and determines whether the sum of the prefixes exceeds a threshold. The threshold can be set by an administrator or can comprise a portion of the total capacity of the prefixes available in the route table. For example, the threshold can represent 80 percent of the total prefix capacity of the router table. When the sum does not exceed the threshold, operational scenario 400 performs add queue prefixes operation 420 that adds the prefixes to the current table without performing any replacement operations using supernets that can combine multiple subnets into a single routing path. In contrast, if the sum does exceed the threshold associated with the route table, operational scenario 400 performs calculate and update supernet operation 430 that replaces a portion of the subnets associated with a route table with one or more supernets.

In some examples, in determining the supernets, the management service will identify the different variations of the first two octets for the route prefixes associated with the route table. For example, a route table can include route prefixes that use 192.168 and 172.170. Once the different variations are identified, the management service will generate a supernet for each of the different octet variations that can act as a stand-in for the subnets that qualify for the supernet. Each supernet can comprise the longest prefix that supports each of the subnets with the matching first two octets.

After the one or more supernets are identified, the one or more supernets are added to the route table to replace the route prefixes for the subnets that are included in the supernets. For example, a first supernet can replace four prefix routes in the route table. The supernet can route to an intermediary router that in turn routes to the corresponding subnets. Thus, rather than including each individual subnet in the route table at the service provider gateway, supernets can support the routing of packets for multiple subnets. A second router can receive the packets for the supernet and forward the packets toward the required destination.

Although demonstrated in the examples of FIG. 1-4 as adding supernets to stand-in for subnet prefixes, similar operations can be performed to remove the supernets when capacity is available at the service provider gateway. For example, during a first period, the management service can use supernets to support segments of virtual machines in a computing environment. The management service can monitor the number of segments or subnets in the environment and can determine when the quantity of subnets falls below a threshold. Once the quantity of segments falls below the threshold, the management service can initiate an operation to replace the supernets with the subnets for the individual segments. The operation can include, for each of the supernets, adding the subset of subnets associated with the supernet to the route table and removing the supernets from the route table once the subnets are available in the table.

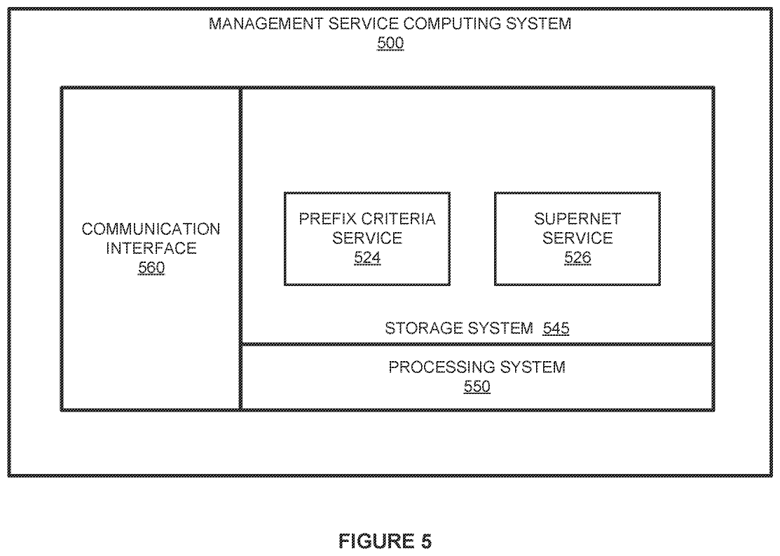

FIG. 5 illustrates a management service computing system 500 to manage supernets in a route table of a gateway according to an implementation. Computing system 500 is representative of any computing system or systems with which the various operational architectures, processes, scenarios, and sequences disclosed herein for a management service can be implemented. Computing system 500 is an example of management service 140 of FIG. 1, although other examples may exist. Computing system 500 includes storage system 545, processing system 550, and communication interface 560. Processing system 550 is operatively linked to communication interface 560 and storage system 545. Communication interface 560 may be communicatively linked to storage system 545 in some implementations. Computing system 500 may further include other components such as a battery and enclosure that are not shown for clarity.

Communication interface 560 comprises components that communicate over communication links, such as network cards, ports, radio frequency (RF), processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format—including combinations thereof. Communication interface 560 can communicate with other gateways, core routers, hosts, or other computing systems to provide networking for virtual machines or other virtualized endpoints in a computing environment. In at least one implementation, communication interface 560 communicates with a T-0 router to provide a configuration of a route table on the T-0 router and can further communicate with one or more T-1 routers to provide configuration information to the routers.

Processing system 550 comprises microprocessor (i.e., at least one processor) and other circuitry that retrieves and executes operating software from storage system 545. Storage system 545 may include volatile and nonvolatile, removable, and non-removable media implemented in any method or technology for storage of information, such as computer readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises prefix criteria service 524 and supernet service 526. The operating software on storage system 545 may further include an operating system, utilities, drivers, network interfaces, applications, or some other type of software. When read and executed by processing system 550 the operating software on storage system 545 directs computing system 500 to operate as described herein. In at least one example, the operating software can provide at least method 200 described above in FIG. 2.

In at least one implementation, prefix criteria service 524 directs processing system 550 to monitor a quantity of prefix routes associated with a route table in a gateway and determine when the quantity satisfies one or more criteria. In some implementations, a route table can support a maximum quantity of prefixes, wherein segments added after the maximum is reached cannot be added to the gateway. Here, prefix criteria service 524 determines when the route prefixes satisfy a threshold quantity usage of the capacity associated with the route table. For example, if the route table can support 100 total route prefixes, the threshold can be set to 80 route prefix entries or 80% of the total capacity. The route prefixes can include the prefixes currently instituted in the route table and the route prefixes that are pending or queued for the route table.

After the threshold is exceeded in association with the route tables, supernet service 526 directs processing system 550 to determine one or more supernets for the route table, wherein the one or more supernets each represent a subset of the prefix routes. As an example, a computing environment can employ or queue a total of eight segments of virtual machines, wherein a first subset of the segments shares prefix portions for a first supernet and wherein a second subset of the segments shares prefix portions for a second supernet. Once the supernets are identified in association with the subnets, the supernets are added to the route table to replace the route prefixes associated with the segments. In some implementations, supernet service 526 directs processing system 550 to determine when the supernets have been added to the route table and made available and, once made available, can remove the route prefixes associated with the segments. The supernets can be used to forward packets to a joint destination (router) and can be distributed as required for processing for the individual segments. The processing can include firewall operations, NAT operations, or some other routing operation in association with the segment.

In some implementations, when the one or more criteria are satisfied to use supernets in association with the segments, supernet service 526 directs processing system 550 to identify potential first sets of bits for the route prefixes. For example, supernet service 526 can identify the potential first two octets associated with the route prefixes (e.g., 192.128 and 172.160). A supernet can be created for each of the potential octets, wherein the supernet will be used for all the route prefixes that share the first two octets. Thus, a subset of route prefixes can be included as part of the supernet for the 192.168 octets and a second subset of route prefixes can be included as part of the supernet for 172.160 octets. Each of the supernets can be represented as a prefix that includes the bits shared by all segments in the supernet.

Although demonstrated in the previous example determining the supernets using a selection of the first two octets, other operations can be used to generate the supernets. These operations can include grouping prefixes with common portions until the usage of the route table is reduced to a defined amount. For example, subnet can be associated with a /24 prefix, but prefixes can be grouped with a prefix that is /19 or some other prefix until the requisite capacity is available in the route table.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method comprising:
monitoring a quantity of prefix routes associated with a route table in a gateway;
determining when the quantity satisfies one or more criteria, the one or more criteria being associated with a quantity of current prefixes in the route table and a quantity of pending prefixes to be added to the route table;
when a capacity satisfies the one or more criteria, determining one or more supernets for the route table, wherein each supernet of the one or more supernets represent a subset of the prefix routes;
adding one or more supernets to the route table; and
removing one or more subsets of the prefix routes represented by the one or more supernets from the route table.

2. (canceled)

3. The method of claim 1, wherein determining when the quantity satisfies the one or more criteria comprises:
determining when the quantity exceeds a threshold value for the route table.

4. The method of claim 1, wherein the prefix routes each represent one or more subnets for virtual machines.

5. The method of claim 1, wherein the gateway comprises a service provider gateway provided by a cloud service provider.

6. The method of claim 1, wherein determining the one or more supernets for the route table comprises:
combining two or more prefix routes of the prefix routes into a first supernet of the one or more supernets.

7. The method of claim 1, wherein determining the one or more supernets for the route table comprises:
determining a quantity of supernets to satisfy a prefix threshold for the route table; and
determining the one or more supernets for the route table based on the quantity of supernets.

8. The method of claim 1 further comprising:
determining when the addition of the one or more supernets to the route table is successful; and
wherein removing the one or more subnets of the prefix routes represented by the one or more supernets occurs in response to determining that the addition of the one or more supernets to the route table was successful.

9. A computing apparatus comprising:
one or more non-transitory computer readable storage media;
at least one processor operatively coupled to the one or more non-transitory computer readable storage media; and
program instructions stored on the one or more non-transitory computer readable storage media that, when executed by the at least one processor, direct the computing apparatus to:
monitor a quantity of prefix routes associated with a route table in a gateway;
determine when the quantity satisfies one or more criteria, the one or more criteria being associated with a quantity of current prefixes in the route table and a quantity of pending prefixes to be added to the route table;
when a capacity satisfies the one or more criteria, determine one or more supernets for the route table, wherein each supernet of the one or more supernets represent a subset of the prefix routes;
add the one or more supernets to the route table; and
remove one or more subsets of the prefix routes represented by the one or more supernets from the route table.

10. The computing apparatus of claim 9, wherein monitoring the quantity of prefix routes associated with the route table in the gateway comprises a sum of a first quantity of prefix routes in the route table and a second quantity of prefix routes queued for the route table.

11. The computing apparatus of claim 9, wherein determining when the quantity satisfies the one or more criteria comprises:
determining when the quantity exceeds a threshold value for the route table.

12. The computing apparatus of claim 9, wherein the prefix routes each represent one or more subnets for virtual machines.

13. The computing apparatus of claim 9, wherein the gateway comprises a service provider gateway of a cloud service provider, and wherein the service provider gateway is coupled to a tier-0 router.

14. The computing apparatus of claim 9, wherein determining the one or more supernets for the route table comprises:
combining two or more prefix routes of the prefix routes into a first supernet of the one or more supernets.

15. The computing apparatus of claim 9, wherein determining the one or more supernets for the route table comprises:
determining a quantity of supernets to satisfy a prefix threshold for the route table; and
determining the one or more supernets for the route table based on the quantity of supernets.

16. The computing apparatus of claim 9, wherein the program instructions further direct the computing apparatus to:
determine when the addition of the one or more supernets to the route table is successful; and
wherein removing the one or more subnets of the prefix routes represented by the one or more supernets occurs in response to determining that the addition of the one or more supernets to the route table was successful.

17. An apparatus comprising:
one or more non-transitory computer readable storage media; and
program instructions stored on the one or more non-transitory computer readable storage media that, when executed by at least one processor, direct the at least one processor to:
monitor a quantity of prefix routes associated with a route table in a gateway;
determine when the quantity satisfies one or more criteria, the one or more criteria being associated with a quantity of current prefixes in the route table and a quantity of pending prefixes to be added to the route table;
when a capacity satisfies the one or more criteria, determine one or more supernets for the route table, wherein each supernet of the one or more supernets represent a subset of the prefix routes;
add one or more supernets to the route table; and
remove the one or more subsets of the prefix routes represented by the one or more supernets from the route table.

18. The apparatus of claim 17, wherein monitoring the quantity of prefix routes associated with the route table in the gateway comprises a sum of a first quantity of prefix routes in the route table and a second quantity of prefix routes queued for the route table.

19. The apparatus of claim 17, wherein the prefix routes each represent one or more subnets for virtual machines.

20. The apparatus of claim 17, wherein the program instructions further direct the at least one processor to:
determine when the addition of the one or more supernets to the route table is successful; and
wherein removing the one or more subnets of the prefix routes represented by the one or more supernets occurs in response to determining that the addition of the one or more supernets to the route table was successful.
